(19) United States
(12) Patent Application Publication
(10) Pub. No.: US 2014/0311583 A1
(43) Pub. Date: Oct. 23, 2014

(54) DEVICE AND A METHOD FOR DEMOUNTING A FLANGE

(71) Applicant: Mark Jans, Kortenhoef (NL)

(72) Inventor: Mark Jans, Kortenhoef (NL)

(21) Appl. No.: 14/254,763

(22) Filed: Apr. 16, 2014

(30) Foreign Application Priority Data
Apr. 17, 2013 (NL) NL2010648

(51) Int. Cl. F16L 23/00

(52) U.S. Cl. CPC F16L 23/003
USPC 137/15.09; 137/312

(57) ABSTRACT

The present invention relates to a device for use with demounting flanges that are coupled by means of flange bolts, comprising a housing with an inside that is embodied for adjacent positioning at a radial outer circumference of said coupled flanges, the device comprising a connection for removal of fluids that is released from between said flanges and the housing being embodied for being positioned against said coupled flanges while not obstructing said flange bolts. The device is characterized in that it further comprises an air intake for supplying air from the surrounding to a space defined by the flanges and the device according to the invention.

The invention also relates to a method for leak-free demounting flanges by using a device according to any of the preceding claims, comprising the step of positioning at a radial outer surface of said coupled flanges said housing, such that a separation seem of said flanges is covered by said device, with the proviso that the flange bolts are held freely; wherein the connection for removal of fluids is connected to a vacuum source or a pump and wherein the air intake provides for an uninterrupted connection between the surrounding and a space defined by the flanges and the device according to the invention.

The present invention relates to a device that can be used when demounting flanges that have been coupled by means of bolts and nuts. The invention also relates to a method for demounting a flange by using the present device.

Such device is new in the art. When demounting flanges from piping, part of the compounds present in said piping will be released through said flanges. Especially when transporting harmful substances, personnel requires protective gear so as to prevent any contact with said substances. Retrieval of any leaked substances is obtained by placing a tray beneath the flange so as to be able to remove said substances, for example through suction. Since such tray usually has a limited capacity, not all substances can be retrieved unless a continuous removal of said substances rom said tray is provided. Anyway, retrieval of gasses is impossible.

From DE202006002457 (D1) a device is known that is embodied for closing off a flange so as to prevent leakage to the environment. However, said device is not embodied for actually emptying piping. Only retrieving limited leakage from a flange that is otherwise closed is possible and envisaged.

As a consequence, a solution is required for the problem that substances (more in particular fluids, like liquids and gasses) are lost when demounting flanges.

The present invention aims at providing a device for safely demounting flanges. The invention also aims at providing a method for solving this problem.

The present invention especially aims at providing a device as mentioned in the preamble which enables one to safely demount flanges. The invention especially aims at providing a device as mentioned in the preamble with which personnel does not or substantially not require safety gear.

The invention also aims at providing a device that can be mounted safely and fast on a set of coupled flanges, such that flange bolts can be reached for disconnecting same whereas any substances from said piping can be discarded securely and safely.

So as to obtain at least one of these advantages, according to a first embodiment the present invention provides a device comprising the features of claim 1. This device has the advantage that substances will be shielded from the surrounding. Any contamination of the environment is adequately prevented. The air intake in the device according to the invention especially ensures an excellent and unrivaled drain of fluids rom said piping.

The device is preferably comprised of two semi-circular segments, such that a first segment is positioned against said flanges from a first side and a second segment is positioned against said flanges from a second, opposite side, after which both segments are connected so as to completely seal said flanges from the surrounding. For example, both semi-circular segments may be mutually connected at first ends by means of a hinge whereas both other ends may be connectable by means of mutually cooperating coupling means, preferably disconnectable coupling means.

It is preferred for the device being embodied to be positioned at an axial part of at least one of said flanges, at a position between said radial outer circumference and the flange bolts. This enables the device to be simply centered on a set of coupled flanges, such that de connecting surface or plane of coupling of said flanges, i.e. the plane in which the surfaces of both flanges are positioned adjacently, is shielded adequately by means of said device.

It is further preferred that an inner part of said housing is embodied to be positioned at a radial outer circumference of said flanges and comprising an insertion device to be inserted between said flanges. The insertion device may be a pen having a sharpened end, such that the pen may be insertable between said flanges so as to move both flanges apart. When said flanges do not move apart automatically when disconnecting said flange bolts, such a pen may provide for such moving apart.

As mentioned before, it is preferred for the insertion device to have a tapered dimension; the end tip of said insertion device has a smaller diameter than a part of the pen at a position away from said end tip. According to a preferred embodiment, said insertion device has a tapered diameter and is situated within said device while being displaceable between a first position and a second position, such that in a first position part of said insertion device having a smallest diameter is positioned relatively close to the inside of said housing and in a second position is situated relatively further away from the inside of said housing. In said second position the insertion device will be displaced to a position between said flanges, such that the flanges move apart since the insertion device has a tapered diameter. The further the insertion device is displaced, the further the flanges move apart, until a maximum diameter of said insertion device has reached a position between said flanges.

So as to obtain a proportional displacement of said flanges around its circumference, it is preferred that said device comprises at least two insertion devices. Optionally, more than two insertion devices may be applied, for example three or even four, so as to move said flanges apart. When the connection for removal of fluids is positioned at a bottom part when using said device, it is preferred that the insertion devices are positioned at a relatively higher position. The insertion devices may also suitably be situated at a bottom half of the flanges. Also optionally, the said connection for removal of fluids, as well as the insertion devices, may be distributed around the devices circumference.

A suitable displacement of said insertion device may be obtained when the insertion device is situated inside an opening of said housing and comprises external thread that cooperates with internal thread inside said opening for enabling said insertion device to be displaced between both positions.

The device provides for an adequate shielding of the environment, or the surroundings in general, with respect to said flanges, when the device can be positioned sealingly against said flanges. To this end, it is preferred for the device to comprise at its inside an elastically deformable material for sealingly positioning said device against said flanges. The said material may be positioned tightly against said flanges so as to obtain said protection. When both flanges are somewhat moved apart any remaining fluid may be simply removed from the space in between said flanges into the connection for removal of fluids. As a matter of fact, the connection should be situated near the flanges' contact surface, so as to enable removal of said fluid.

Within the present invention, the term “contact surface of said flanges” is meant to indicate the plane or the space positioned between said flanges. In practice, a gasket or packing ring will be positioned in between said flanges. When there is mentioning of two flanges positioned against each other, also the situation where a gasket or packing ring is situated in between said flanges is meant as well. Within the present invention, the gasket or packing ring may be provided over the entire flange surface, or over just part of said surface. Such flanges comprising a shoulder, with the consequence that part of said surface is positioned at a distance from the other flange whereas another part of said surface is in contact with said other flange, as in so-called RF flanges, are also embodied by the present invention.

The invention also relates to a device wherein, when using said device, a space is obtained in which fluids that is released from between the flanges can be contained, said space being defined by the inside of said housing, a first deformable material against a first flange, a second deformable material against a second flange and the radial surface of said coupled flanges. According to such embodiment, the device is not tightly contacting the complete radial surface of both flanges, but only part of said surface; or optionally only against the axial surfaces of said flanges.

As a consequence, the invention also relates to a device wherein the elastically deformable material is situated sealingly against the radial surface of said coupled flanges.

According to a further aspect of the present invention, the invention also relates to a method for leak-free demounting flanges using the device according to the present invention. The method comprises the steps of positioning at a radial outer surface of said coupled flanges said housing, such that a separation seem of said flanges is covered by said device, with the proviso that the flange bolts are held freely. It is further preferred that the connection for removal of fluids is connected to a vacuum source or a pump and wherein the air intake provides for an uninterrupted connection between the surrounding and a space defined by the flanges and the device according to the invention. The advantages as mentioned above with regard to the device may be obtained with this method. Preferably, the separation seam of said flanges is sealed from the environment, such that a substantially fluid tight and gas tight seal with respect to the surroundings or environment is obtained. To the connection for removal of fluids a vacuum source or pump or the like is connected, thus creating a reduced pressure in said space near said flanges. According to the present invention an air intake (also identified as air connection) is provided in the device according to the present invention so as to take in air from the environment within the space defined by the device according to the invention and the flanges. As a consequence, fluids will not leak into the environment. Furthermore, it is preferred that the suction means is activated before said flanges are disconnected, thus minimizing the chance of leaking of fluids.

The connection for removal of fluids is situated at a lower position than the air intake, so as to not hinder the removal of fluids through any air entering said space.

The air intake connection may comprise a closeable opening, for example a manually operable or automated valve, but a one way valve may be applied as well, such one way valve allowing air to enter from the surrounding into said space only when a vacuum source is connected to said device for removal of fluid. As a consequence, an excellent removal of fluids is obtained at all times, whereas fluids will not escape through said air intake into the environment.

Preferably, the method according to the invention also comprises the step of coupling a suction means (for example by means of a vacuum tube) to the connection for removal of fluids that is released from between said flanges and disconnecting the flange bolts. Any fluid remaining in the piping will thus be easily, safely and fast be removed, without any contamination of the environment. Personnel disconnecting the flanges needs no or substantially no safety gear.

So as to be able to disconnect stuck and clamping flanges it is preferred for the method according to the invention to further comprise the step of positioning an insertion device between said flanges.

So as to prevent an axial displacement of the device during disconnecting the flange bolts at least partially, it is preferred that the method further comprises the step of positioning at an axial side of the flanges positioning devices for at least partially preventing a axial displacement of the device when disconnecting the flange bolts. These may be pens or the like, that are situated at axial sides of the flanges. They may be situated at some limited distance from the flanges, such that a tolerance of the device over less than or more than a centimeter is obtained. In this respect, it is required for the contact plane of the flanges to remain covered by the device according to the invention.

The device furthermore preferably comprises an air intake so as be able to entrain air from the surrounding within the device or between said flanges so as to prevent evacuation of the piping.

Hereafter, the invention will be explained by means of a drawing. The drawing shows in:

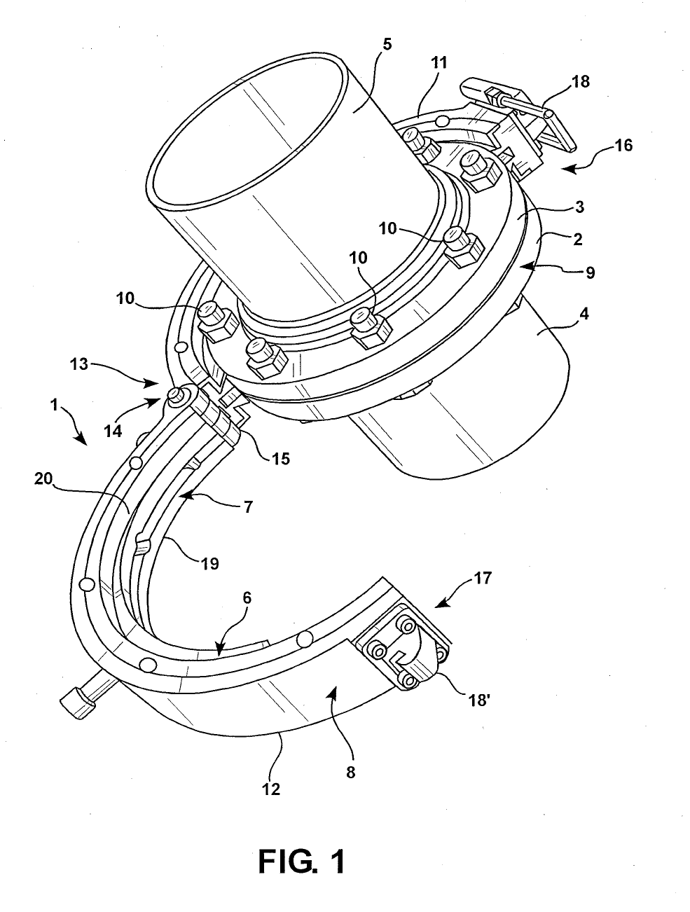

FIG. 1 a schematic view of the device according to the invention and a set of coupled flanges,

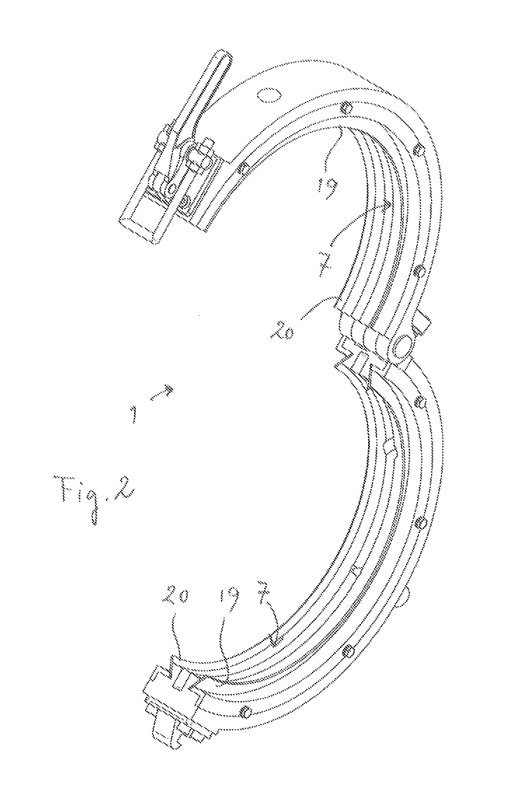

FIG. 2 a schematic view of the device according to the invention,

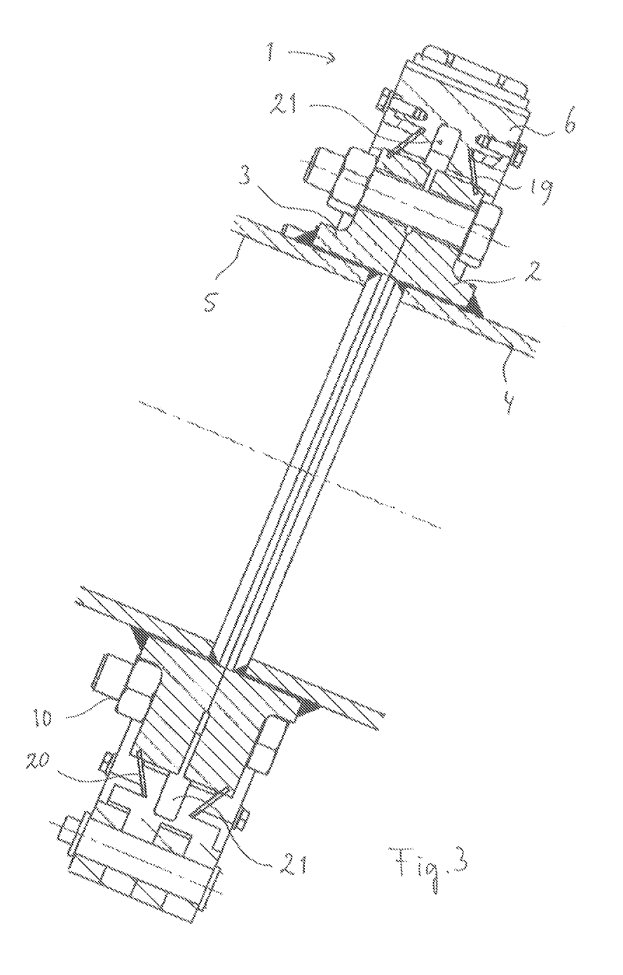

FIG. 3 a sectional view of the device according to the invention positioned around a set of coupled flanges, and

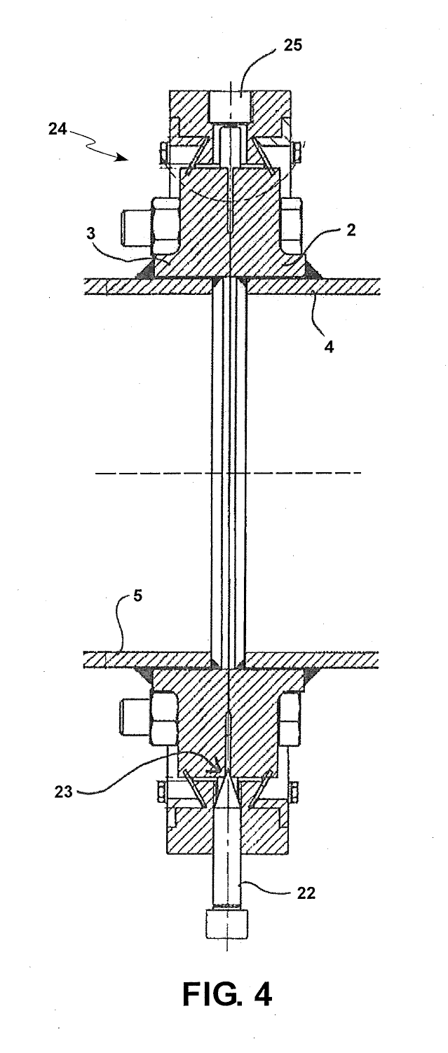

FIG. 4 a sectional view of the device according to the invention comprising an insertion device and an air intake.

In the drawings, the same parts have been denoted by the same reference numerals. However, for ease of understanding the drawing, not all parts that will be required for a practical embodiment of the invention have been denoted and described.

FIG. 1 shows a schematic view of a device 1 in an open state positioned around a set of coupled flanges 2, 3. Said flanges 2, 3 are connected to piping 4 and 5, respectively. Between said flanges 2, 3 a gasket (not shown) is situated so as to provide an adequate sealing. Device 1 comprises a housing 6 having an inside 7 and an outside 8. Said inside 7 is, when in use, positioned against radial outer surface 9 of said flanges 2, 3.

Said flanges are coupled by means of flange bolts 10.

Device 1 is comprised of two mutually cooperating parts 11, 12. Both parts 11, 12 each are shaped as semi-circular segments, such that the device 1 can be easily positioned around a set of coupled flanges 2, 3, as shown in FIG. 1, wherein a first part 11 is positioned against radial outer surface 9 of coupled flanges 2, 3 and said other part 12 is positioned at a distance therefrom. In the embodiment shown, both parts 11, 12 are mutually coupled through a hinge 15 at first ends 13, 14. The other ends 16, 17 are connectable mutually releasably by means of a hook connection 18, 18′.

At its inside 7, device 1 comprises resiliently compressible sealing means 19, 20. These provide for a substantially fluid tight and gas tight seal of the space confined by the radial flange surface 9, sealing means 19, 20 and the inside 7 of the device 1. When the flanges are disconnected, fluid from piping 4, 5 will enter the said space and will not leak to the surrounding. Even if no fluid tight and gas tight seal is obtained, the underpressure inside said space, provided by the suction means, will ensure confinement of said fluids inside said space and that the fluids will not escape to the surroundings. As shown in FIG. 1 the device 1 is constructed such that the flange bolts 10 remain engageable when the device is positioned on a set of coupled flanges.

FIG. 2 shows a schematic view of the device 1 without flanges 2, 3 and piping 4, 5.

In FIG. 3 a sectional view of device 1 is shown being positioned around a set of coupled flanges 2, 3 with piping 4, 5. Housing 6 constitutes a space 21, together with outer surface 9 of flanges 2, 3 and sealing means 19, 20. In this space 21 fluid from piping 4, 5 may enter, through an opening between flanges 2, 3 when said flanges 2, 3 are moved apart when disconnecting the flange bolts 10. The term “flange bolt” relates to a combination of bolt and nut, as usually applied for mutually coupling two flanges.

Finally, FIG. 4 shows a sectional view substantially identical to FIG. 3, with the proviso that an insertion device 22 comprising a tapered part 23 is inserted partially in between two flanges 2, 3. In the embodiment shown, the insertion device 22 has outer thread that is embodied to cooperate with inner thread provided at the inside of an opening in device 1, such that turning the insertion device 22 in a first direction provides for a displacement of said insertion device towards the flanges 2, 3. As a consequence, flanges 2, 3 are moved apart when flange bolts 10 are disconnected.

Fluid from piping 4, 5 and from between both flanges 2, 3 will reach the connection through space 23, to which a discharge piping may be connected, said discharge piping for example and preferably being connected to a vacuum source or a pump (not shown) such that all fluids will be removed and stored through said discharge piping, so as to prevent said fluids to end up in the environment. Personnel disconnecting flanges 2, 3 do not need any or substantially no protective gear.

Furthermore, an air intake connection 25 is shown, for having air entering (i.e. aerating) the piping and the space between the device 1 and the flanges, when discharging fluids therefrom. The air intake connection 25 serves as an intake for air towards the space that is confined by the device 1 and the flanges. It has shown that discharge of fluids by using a device according to the present invention is considerably improved when air is taken in from the surrounding through such air intake 25.

The pump or vacuum source may be a separate pump or a vacuum truck, in which the fluids may be stored. Within the present invention, the phrase “vacuum source” should be broadly interpreted and relates to any source that has a lower pressure than the pressure inside the space between the device according to the present invention and the flanges.

The device according to the present invention may comprise a provision for holding a handling member for an insert flange or the like, such that a leak free sealing is obtained so as to prevent any leakage to the environment, even when applying such insert flange.

The invention is not limited to the embodiments as described above and as shown in the drawing. The invention is limited by the claims only.

For example, the device 1 may, over its entire surface or over part of its surface, at its inside be provided with a elastically deformable material, such that the surface between both flanges 2, 3 is covered sealingly. As a consequence, fluids from piping 4, 5 and from between both flanges 2, 3 cannot escape to the environment 24.

Where there is mentioning in the present description of a fluid tight and gas tight sealing between the flanges and the device according to the present invention, a substantially fluid tight and gas tight sealing is meant.

The invention also covers all combinations of features that have been described en mentioned independently or in combination within the present description.

1. A device for use with demounting flanges that are coupled by means of flange bolts, comprising a housing with an inside that is embodied for adjacent positioning at a radial outer circumference of said coupled flanges, the device comprising a connection for removal of fluids that is released from between said flanges and the housing being embodied for being positioned against said coupled flanges while not obstructing said flange bolts, wherein the device further comprises an air intake for supplying air from the surrounding to a space defined by the flanges and the device according to the invention.

2. A device according to claim 1, said device being embodied to be positioned at an axial part of at least one of said flanges, at a position between said radial outer circumference and the flange bolts.

3. A device according to claim 1, wherein an inner part of said housing is embodied to be positioned at a radial outer circumference of said flanges and comprising an insertion device to be inserted between said flanges.

4. A device according to claim 3, said insertion device comprising a tapered diameter and being situated within said device while being displaceable between a first position and a second position, such that in a first position part of said insertion device having a smallest diameter is positioned relatively close to the inside of said housing and in a second position is situated relatively further away from the inside of said housing.

5. A device according to claim 3, the device comprising at least two insertion devices.

6. A device according to claim 1, the insertion device being situated inside an opening of said housing and comprising external thread that cooperates with internal thread inside said opening for enabling said insertion device to be displaced between both positions.

7. A device according to claim 1, the device comprising at its inside an elastically deformable material for sealingly positioning said device against said flanges.

8. A device according to claim 7, wherein, when using said device, a space is obtained in which fluids that is released from between the flanges can be contained, said space being defined by the inside of said housing, a first deformable material against a first flange, a second deformable material against a second flange and the radial surface of said coupled flanges.

9. A device according to claim 7, the elastically deformable material being situated sealingly against the radial surface of said coupled flanges.

10. A method for leak-free demounting flanges by using a device according to claim 1, comprising the step of positioning at a radial outer surface of said coupled flanges said housing, such that a separation seem of said flanges is covered by said device, with the proviso that the flange bolts are held freely; wherein the connection for removal of fluids is connected to a vacuum source or a pump and wherein the air intake provides for an uninterrupted connection between the surrounding and a space defined by the flanges and the device according to the invention.

11. A method according to claim 10, wherein the connection for removal of fluids is situated at a lower position than the air intake.

12. A method according to claim 10, further comprising the step of coupling a suction means to the connection for removal of fluids that is released from between said flanges and disconnecting the flange bolts.

13. A method according to claim 10, further comprising the step of positioning an insertion device between said flanges.

14. A method according to claim 10, further comprising the step of positioning at an axial side of the flanges positioning devices for at least partially preventing a axial displacement of the device when disconnecting the flange bolts.
